(19) United States
(12) Patent Application Publication
(10) Pub. No.: US 2016/0226578 A1
(43) Pub. Date: Aug. 4, 2016

(54) MANAGEMENT OF FRAME ALIGNMENT EVENTS IN OPTICAL TRANSPORT NETWORKS

(71) Applicants: Catherine H. Yuan, Plano, TX (US); David Solomon, River Vale, NJ (US); Vikas Mittal, Murphy, TX (US); Biaodong Cai, San Ramon, CA (US); Sanjay Gera, Plano, TX (US)

(72) Inventors: Catherine H. Yuan, Plano, TX (US); David Solomon, River Vale, NJ (US); Vikas Mittal, Murphy, TX (US); Biaodong Cai, San Ramon, CA (US); Sanjay Gera, Plano, TX (US)

(21) Appl. No.: 14/614,150

(22) Filed: Feb. 4, 2015

(51) Int. Cl. H04B 10/079; H04L 7/00

(52) U.S. Cl. CPC H04B 10/0795; H04L 7/0075

(57) ABSTRACT

Methods and systems are provided for management of frame alignment events in optical transport networks. The method includes receiving a plurality of frames by a network element and detecting a frame alignment event by the network element. The method further includes receiving a characteristic information (CI) signal by the network element, and disabling, based on the received CI signal, monitoring of a status field for a finite period.

### TECHNICAL FIELD

The present disclosure relates to communications systems and more specifically, to management of frame alignment events in optical transport networks.

### BACKGROUND

Telecommunications systems, cable television systems, and data communication networks use communication networks to rapidly exchange large amounts of information between remote points. A communication network may include network elements that route digital signals, including digital data packets and data frames, through the network. Some network elements may include a distributed architecture, wherein packet processing may be distributed among several subsystems of the network element (e.g., line cards).

Communications over optical communication lines are often encoded using the Synchronous Digital Hierarchy (SDH), Synchronous Optical Networking (SONET), or Optical Transport Network (OTN) standards. Communications networks are often configured as an OTN as defined by the International Telecommunications Union Telecommunication Standardization Sector (ITU-T) Recommendations G.709 and G.798, and a plurality of related standards as referenced by the said recommendations. A particular OTN may include a plurality of network elements for carrying traffic between two or more clients. Frame alignment bytes are carried in the overhead of a frame. The ITU-T G.798 standard provides for actions when frame alignment is missing that include monitoring the OTN status overhead (STAT) signal and subsequent alarms.

### SUMMARY

In particular embodiments, a method includes receiving a plurality of frames by a network element and detecting a frame alignment event by the network element. The method further includes receiving a characteristic information (CI) signal by the network element, and disabling, based on the received CI signal, monitoring of a status field for a finite period.

In another embodiment, a network element includes a processor configured to receive a plurality of frames and detect a frame alignment event. The processor is further configured to receive a characteristic information (CI) signal, and disable, based on the received CI signal, monitoring of a status field for a finite period.

In another embodiment, a network element includes a processor configured to receive a plurality of frames and detect a frame alignment event. The processor is further configured to, based on the frame alignment event, delay declaring a fault condition until a preset number of frames is received by the network element

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a block diagram of selected elements of an example network in accordance with some embodiments of the present disclosure;

FIG. 2 illustrates a block diagram of details of selected network elements of an example optical transport network (OTN) in accordance with some embodiments of the present disclosure;

FIG. 3 illustrates an exemplary optical transport unit (OTU) frame that may include frame alignment signal (FAS) bytes in accordance with some embodiments of the present disclosure; and

FIGS. 4 and 5 illustrate flow charts of methods for management of frame alignment events in accordance with some embodiments of the present disclosure.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget 12-1 refers to an instance of a widget class, which may be referred to collectively as widgets 12 and any one of which may be referred to generically as a widget 12.

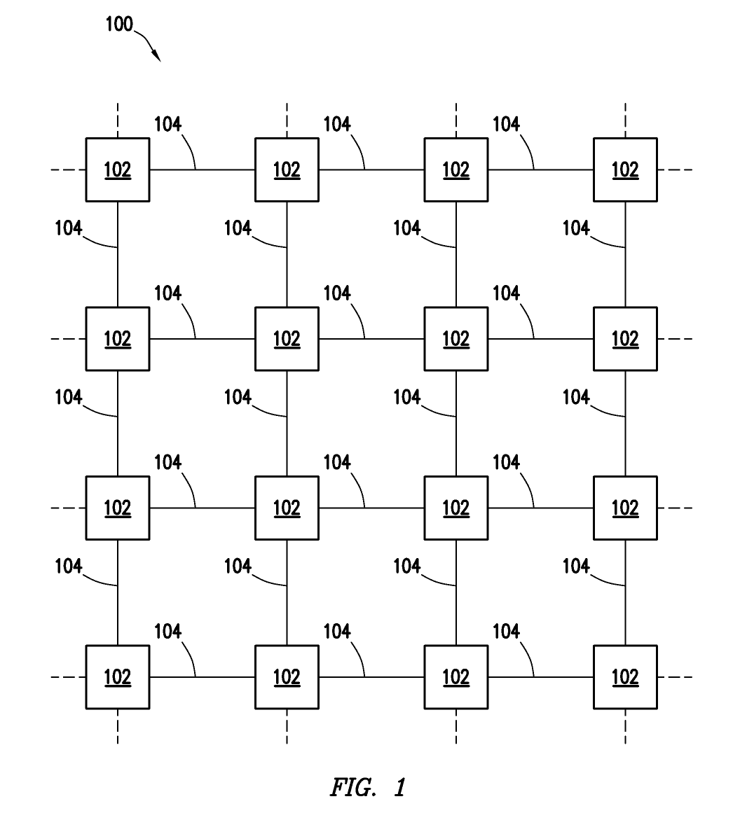

FIG. 1 illustrates a block diagram of selected elements of example network 100 in accordance with some embodiments of the present disclosure. In certain embodiments, network 100 may be an optical transport network (OTN), a T-carrier network, an Ethernet network, a wireless network, or a mixture of these network types. A communication network may include nodes and transmission media that facilitate communication between nodes within the network. The communication of signals or data between and within nodes may be referred to as “traffic.” Network 100 may include one or more transmission media 104 operable to transport one or more signals communicated by components of network 100. In some embodiments the nodes may be network elements 102 that receive or transmit traffic within the network. Transmission media 104 may be configured to couple network elements 102 and carry traffic between network elements 102. In the illustrated network 100, each network element 102 is coupled to four other nodes. However, any suitable configuration of any suitable number of network elements 102 may create network 100. Although network 100 is shown as a mesh network, network 100 may also be configured as a ring network, a point-to-point network, or any other suitable network or combination of networks. In certain embodiments, the network may be a communication network. A communication network allows nodes (e.g., network elements 102) to communicate with other nodes. A communication network may comprise all or a portion of one or more of the following: a public switched telephone network (PSTN), a public or private data network, a local area network (LAN), a metropolitan area network (MAN), a long-haul inter-city network, a wide area network (WAN), a local, regional, or global communication or computer network such as the Internet, a wireline or wireless network, an enterprise intranet, other suitable communication link, or any combination of any of the proceeding.

In some embodiments, network 100 may comprise an OTN. Traffic may be transmitted by network elements 102 within an OTN according to various protocols such as ITU-T G.709 and G.798 standards. Network elements 102 may transmit traffic in data packets or frames known as Optical Transport Unit (OTU) frames.

Each transmission medium 104 may include any system, device, or apparatus configured to communicatively couple network elements 102 to each other and communicate information between corresponding network elements 102. For example, a transmission medium 104 may include an optical fiber, an Ethernet cable, a T1 cable, a WiFi signal, a Bluetooth signal, or other suitable medium.

Network 100 may communicate traffic over transmission media 104. Traffic may be information transmitted, stored, or sorted within the communication network. Such traffic may comprise optical or electrical signals configured to encode audio, video, textual, or any other suitable data. The data may also be transmitted in a synchronous or asynchronous manner, and may be transmitted deterministically (also referred to as “real-time”) and/or stochastically. Traffic may be communicated via any suitable communications protocol, including, without limitation, the Open Systems Interconnection (OSI) standard and Internet Protocol (IP). Additionally, traffic communicated via network 100 may be structured in any appropriate manner including, but not limited to, being structured in frames, packets, or an unstructured bit stream.

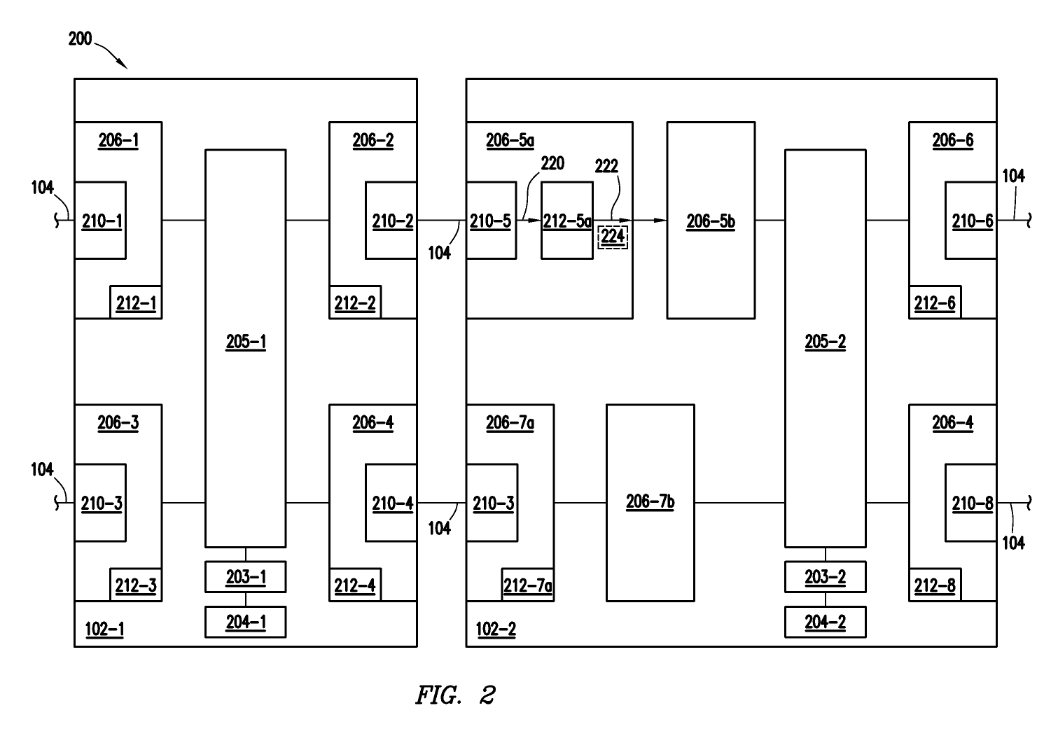

Each network element 102 in network 100 may comprise any suitable system operable to transmit and receive traffic. In the illustrated embodiment, each network element 102 may be operable to transmit traffic directly to one or more other network elements 102 and receive traffic directly from the one or more other network elements 102. Network elements 102 will be discussed in more detail below with respect to FIG. 2.

A component of network 100 and/or a network element 102 may include an interface, logic, memory, and/or other suitable element. An interface receives input, sends output, processes the input and/or output, and/or performs other suitable operations. An interface may comprise hardware and/or software.

A link may describe the communicative connection between two adjacent network elements 102. A link may be a physical or logical connection between adjacent nodes. A physical link may include the corresponding ports and transmission media 104 that couple adjacent network elements 102 to each other.

Logic performs the operations of the component, for example, executes instructions to generate output from input. Logic may include hardware, software, and/or other logic. Logic may be encoded in one or more tangible computer-readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to network 100 without departing from the scope of the disclosure. The components and elements of network 100 described may be integrated or separated according to particular needs. Moreover, the operations of network 100 may be performed by more, fewer, or other components.

FIG. 2 illustrates a block diagram of details of selected network elements 102 of example OTN 200 in accordance with some embodiments of the present disclosure. As discussed above, each network element 102-1 and 102-2 may be coupled to one or more other network elements 102 via one or more transmission media 104. In some embodiments, however, not all network elements 102 may be directly coupled as shown in FIG. 1. Each network element 102 may generally be configured to receive data from and/or transmit data to one or more other network elements 102. In certain embodiments, network element 102 may comprise a switch or router configured to transmit data received by network element 102 to another device (e.g., another network element 102) coupled to network element 102. Each network element 102 may be any system, apparatus or device that may be configured to route traffic through, to, or from a network. Examples of network elements 102 include routers, switches, reconfigurable optical add-drop multiplexers (ROADMs), wavelength division multiplexers (WDMs), access gateways, intra-connected switch pair, endpoints, softswitch servers, trunk gateways, or a network management system. In some embodiments, components of network elements 102 may include computer-readable media encoded with a computer program, software, computer executable instructions, or instructions capable of being executed by a computer. The computer-readable media may perform the operations of the network elements 102 or components within network elements 102. In some embodiments, computer-readable media storing a computer program, embodied with a computer program, encoded with a computer program, having a stored computer program or having an encoded computer program may perform the operations of the embodiments. As depicted in FIG. 2, each network element 102 may include processor 203, memory 204, switching element 205, and network interfaces 206 communicatively coupled to switching element 205.

Each processor 203 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 203 may interpret and/or execute program instructions and/or process data stored in memory 204 and/or another component of network element 200. Although FIG. 2 depicts processor 203 as independent of other components of network element 102, in some embodiments one or more processors 203 may reside on network interfaces 206 and/or other components of network elements 102. In operation, processor 203 may process and/or interpret traffic received at physical ports 210. Accordingly, processor 203 may receive traffic from, or transmit traffic to physical ports 210 and network interfaces 206 via switching element 205.

Each memory 204 may be communicatively coupled to processor 203 and may include any system, device, or apparatus configured to retain program instructions and/or data for a period of time (e.g., computer-readable media). Memory 204 may include random access memory (RAM), electrically erasable programmable read-only memory (EEPROM), a PCMCIA card, flash memory, magnetic storage, opto-magnetic storage, or any suitable selection and/or array of volatile or non-volatile memory that may retain data after power to network element 102 is turned off. Although FIG. 2 depicts memory 204 as independent of other components of network element 102, in some embodiments one or more memories 204 may reside on network interfaces 206 and/or other components of network element 102.

Each switching element 205 may include any suitable system, apparatus, or device configured to receive traffic via physical port 210 and forward such traffic to a particular network interface 206 and/or physical port 210 based on analyzing the contents of the frames or packets carrying the traffic and/or based on a characteristic of a signal carrying the frames or packets (e.g., a wavelength and/or modulation of the signal). For example, in certain embodiments, switching element 205 may include a switch fabric (SWF).

Each network interface 206 may be communicatively coupled to switching element 205 and may include any suitable system, apparatus, or device configured to serve as an interface between network element 102 and transmission medium 104. Network interfaces 206 may include any system, apparatus or device configured to receive input, send output, process the input or output, or perform other suitable operations. Each network interface 206 may enable its associated network element 102 to communicate to other network elements 102 using any suitable transmission protocol and/or standard. Network interface 206 and its various components may be implemented using hardware, software, or any combination thereof. For example, in certain embodiments, one or more network interfaces 206 may include a network interface card. In some embodiments, one or more network interfaces 206 may include a line card. Further, although network elements 102 are depicted with four interfaces, network elements 102 may include any number of network interfaces. In some embodiments, each network interface 206 may include one or more communicatively coupled blocks. For example, network interface 206-5 may include blocks shown as network interface 206-5a and 206-5b, and network interface 206-7 may include blocks shown as network interface 206-7a and 206-7b.

As depicted in FIG. 2, each of network interfaces 206 may include one or more physical ports 210. Each physical port 210 may include any system, device or apparatus configured to serve as a physical interface between a corresponding transmission medium 104 and network interface 206. For example, each physical port 210 may comprise an Ethernet port, a BNC connector, an optical port, or any other suitable port.

As depicted in FIG. 2, each of network interfaces 206 may include frame alignment detector 212, for example network interface 206-5a may include frame alignment detector 212-5a. Frame alignment detector 212-5a may include any system, device or apparatus configured to detect a sequence of framing bits within a digital signal received by network interface 206-5a via a port 210. For example, frame alignment detector 212-5a may include one or more state machines, processors, memories, dedicated circuits, or any combination thereof. In some embodiments, frame alignment detector 212-5a may be implemented on an application-specific integrated circuit (ASIC) or a field-programmable gate array (FPGA). Although FIG. 2 depicts frame alignment detector 212-5a as residing on network interface 206-5a, in some embodiments frame alignment detectors may reside on other components of network element 102 or may be independent of other components of network element 102. Network interface 206-5a, or other component of network element 102, may be configured to use frame alignment detector 212-5a to determine the frame alignment of frames received. For example, as frames are received, frame alignment bytes are analyzed and compared to previous frames to determine alignment or misalignment.

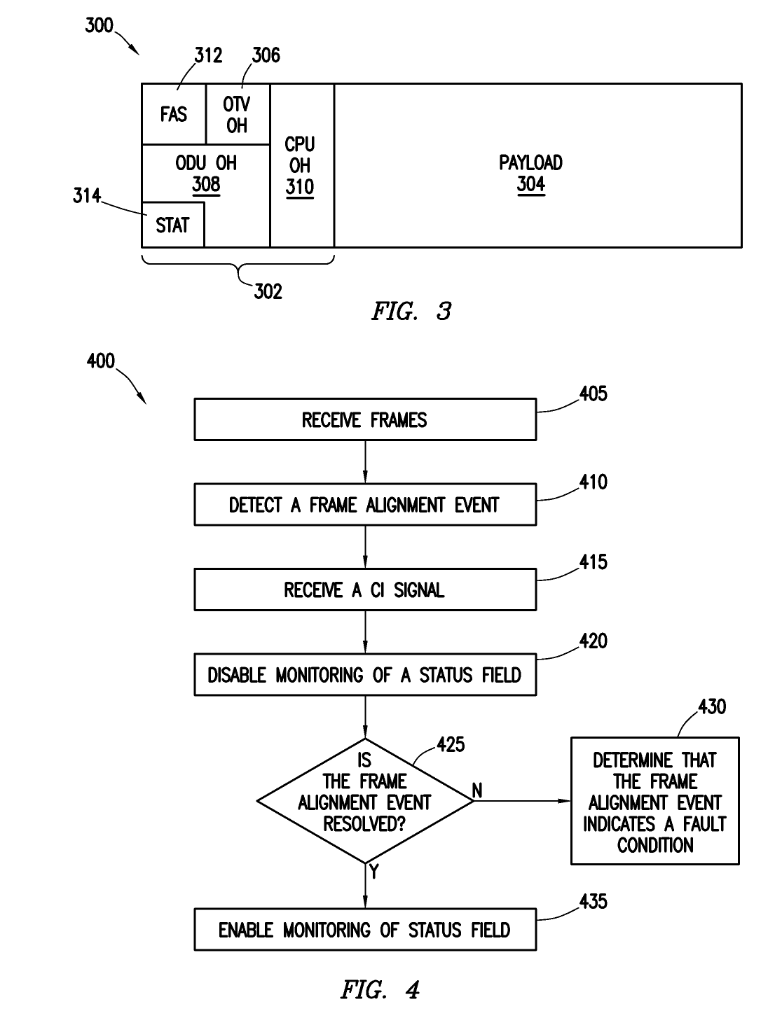

FIG. 3 illustrates an exemplary OTU frame 300 that may include frame alignment signal (FAS) bytes 312 in accordance with some embodiments of the present disclosure. OTU frame 300 may include overhead bytes 302 and payload 304. Overhead bytes 302 may be divided between OTU overhead bytes 306, Optical Data Unit (ODU) overhead bytes 308, and Optical Payload Unit (OPU) overhead bytes 310.

In some embodiments, OTU frames 300 may include FAS bytes 312 for transmissions. FAS bytes 312 may be used to synchronize communication between two network elements. The frame alignment process has two states: out-of-frame (OOF) and in-frame (IF). Specifically, the alignment of OTU frame 300 may be found by searching the FAS bytes 312 in the first row of OTU frame 300 for a sub-pattern of bytes. For example, when the sub-pattern of bytes 3, 4, and 5 of the FAS bytes 312 matches OA1, OA2, OA2 (here OA1 represents “11110110” and OA2 represents “00101000”), it is determined that a frame alignment state, e.g., IF state, is obtained. If the frame alignment is confirmed in the next frame period, the IF state is entered. In the IF state, FAS bytes 312 are continuously checked for correct alignment. The OOF state is entered if the correct pattern of sub-pattern of bytes 3, 4, and 5 value is not found at the correct position in five consecutive frames. The OOF state serves as a preliminary indicator of a misalignment or missing frames. OTU loss-of-frame (LOF) is declared if the frame alignment process is in the OOF state for a predetermined period of time. In one embodiment, this predetermined period of time is approximately three milliseconds. Additionally, a signal server failed (SSF) may be passed downstream via a characteristic information (CI) signal, e.g., CI_SSF signal, when LOF is indicated. LOF is cleared when the IF state persists continuously for a predetermined period of time. In some embodiments, this predetermined period of time is approximately three milliseconds. In the three milliseconds or other predetermined period of time that the communication is in the OOF state before LOF is declared, many frames may be forwarded. For example, between approximately thirty frames for ODU0 protocol to approximately 2,568 frames for ODU4 protocol may be forwarded in this approximately three millisecond period of time. Forwarding frames in the OOF state prior to a LOF (CI_SSF) without any indication may result in misinterpretation in status (STAT) field monitoring.

Status (STAT) field 314 maintains a current 3-bit value that indicates ODU status and can be decoded after the received frame attains frame alignment based on FAS bytes 312. Further, there may be multiple STAT fields in a single OTN frame for different segments. STAT field 314 is located in the ODU overhead bytes 308 of OTU frame 300. STAT field 314 is monitored by downstream blocks under the current standard specification (e.g., ITU-T G.798 standard). When a frame alignment event occurs (e.g., frame alignment missing or misaligned), the STAT field 314 may be monitored at an incorrect position. Monitoring the STAT field 314 at an incorrect position by the downstream blocks may trigger a protection switch or other alarms. However, as discussed in detail below, such alarms may be inappropriate.

When STAT field 314 is monitored at an incorrect position, subsequent actions including alarms may be executed or indicated. For example, in ODU tandem connection monitoring (TCM), the loss-of-tandem connection (LTC) condition may be declared when the tandem connection is in use and the received value in STAT field 314 is [000] in three consecutive frames. The additional alarms or signals may be raised including: alarm indication signal (AIS), locked defect (LCK), and open connection indication (OCI). Further, STAT field 314 is monitored continuously, irrespective of whether an actual frame alignment failure occurs or if the frame alignment is missing due to an intentional frame timing change.

However, in many situations, an alarm or signal may not be appropriate. For example, an intentional frame alignment timing change may be occurring. Frame alignment timing change may take up to five frames to be complete. Thus, it may be useful to stop or delay an alarm and verify that the alarm is necessary before triggering. The present disclosure contemplates multiple methods to stop or delay an alarm to verify that the alarm is appropriate.

In some embodiments, because an intentional frame timing event (such as, an intentional frame alignment timing change or other event) may take a particular number of frames, the timing of raising an alarm may be delayed until after the particular number of frames. For example, a frame timing change would take five frames. Thus, instead of declaring TCM LTC after three consecutive frames of the value [000] appearing in STAT field 314, portions of OTN 200 may be configured to delay and declare TCM LTC after approximately six or seven consecutive frames with the value [000] appearing in STAT field 314. In this manner, OTN 200 may allow for an intentional frame timing event to occur and the frame alignment may reenter the IF state prior to an alarm being mis-claimed.

In other embodiments, OTN 200 may be configured to suspend or temporarily cease monitoring of STAT field 314 during an intentional frame timing event. For example, an additional CI signal may be communicated downstream that causes the downstream blocks or components to cease monitoring STAT field 314 for a predetermined number of frames and/or a finite period. In some embodiments, the CI signal may be a CI frame alignment (FA) missing signal, e.g., CI_FA_missing, or other suitable signal. Communication of the CI_FA_missing signal may indicate to a downstream component to disable monitoring of STAT field 314. Disabling monitoring of STAT field 314 may avoid raising an inappropriate alarm (e.g., LTC, AIS, LCK, OCI) and avoid sympathetic protection switch (when applicable).

Returning to the example of FIG. 2, network elements 102, such as network elements 102-1 and 102-2, may be executing an intentional frame timing change. However, because it may take five frames to complete a frame timing change, STAT field 314 is still monitored at the previous timing for approximately five frames. Thus, before the frame timing change is complete, an erroneous AIS/LCK/OCI/LTC alarm may be triggered. Accordingly, in some embodiments, erroneous alarms or signals may be mitigated or eliminated by transmitting an additional CI signal to downstream blocks.

In some embodiments, frame alignment detector 212-5a may include data input line 220 and data output line 222. Data input line 220 receives data bits that have arrived at a network interface 206-5a. In some embodiments, data input line 220 receives data bits as they are delivered to a port 210-5. In some embodiments, data bits may be stored, for example in a memory, for some period of time between their arrival at network interface 206-5a and delivery to data input line 220.

In some embodiments, frame alignment detector 212-5a may monitor the frames and determine if the proper sequence of framing bits is present. When the proper framing bits are not present, frame alignment detector 212-5a may generate CI signal 224 to send to a downstream block. For example, CI signal 224, e.g., a CI_FA_missing signal, may be created and sent downstream to network interface 206-5b when frame timing is changed. CI signal 224 may be sent after one frame is detected as missing the proper framing bits. CI signal 224 may be sent to network interface 206-5b via output line 222.

When CI signal 224 is received, the downstream blocks ignore or otherwise cease monitoring STAT field 314. For example, network interface 206-5b may ignore or otherwise cease monitoring STAT field 314 while CI signals 224, e.g., a CI_FA_missing signal, is transmitted. In some embodiments, the downstream block may ignore or otherwise cease monitoring STAT field 314 until a predetermined number of consecutive correct frame alignments are detected, which may be a finite period of time. For example, network interface 206-5b may ignore or otherwise cease monitoring STAT field 314 until approximately two consecutive correct frame alignments (e.g., IF state).

In operation, with reference to FIG. 2, frames may be received at network interface 206-1 of network element 102-1, which may comprise a protection switch. Frames may be passed to switching element 205-1 and an alignment timing change may occur in some of the frames. A frame with updated frame alignment timing may be passed to network interface 206-2 and forwarded to network interface 206-5. Network interface 206-5a also initiates CI signal 224, e.g., a CI_FA_missing signal, to network interface 206-5b. The CI_FA_missing signal may be inserted as an out-of-band signaling between the blocks of the network interface (e.g., from network interface 206-5a to network interface 206-5b). As previously noted, the CI_FA_missing signal may indicate that an intentional frame timing change is occurring, and consequently, the STAT field should not be monitored until the frame timing change is complete.

Network interface 206-5b receives and processes the frame from network interface 206-5a and detects a frame alignment event, e.g., frame alignment missing or misaligned. For example, network interface 206-5b may detect that STAT field 314 has a value of [000]. Because network interface 206-5b also receives CI signal 224, e.g., the CI_FA_missing signal, network interface 206-5b ceases monitoring STAT field 314. In some embodiments, network interface 206-5b ceases monitoring STAT field 314 for as long as it receives CI signal 224, e.g., the CI_FA_missing signal. In some embodiments, network interface 206-5b ceases monitoring STAT field 314 until approximately two consecutive correct frame alignments (e.g., IF state) are detected. After the IF state is indicated for a predetermined number of frames (e.g., approximately two frames), network interface 206-5b may again monitor STAT field 314 and determine if an alarm should be indicated.

In some embodiments, network interface 206-5b may forward the frame and the CI signal downstream to switching element 205-2, to any other component of network element 102-2, or to another network element. Because any downstream block also receives CI signal 224, e.g., the CI_FA_missing signal, downstream blocks may also cease monitoring STAT field 314 for as long as CI signal 224, e.g., the CI_FA_missing signal, is detected, or until the IF state is indicated.

Modifications, additions, or omissions may be made to OTN 200 without departing from the scope of the disclosure. For example, OTN 200 may include more than the two network elements 102 depicted. Further, OTN 200 may include more or fewer transmission medium 104.

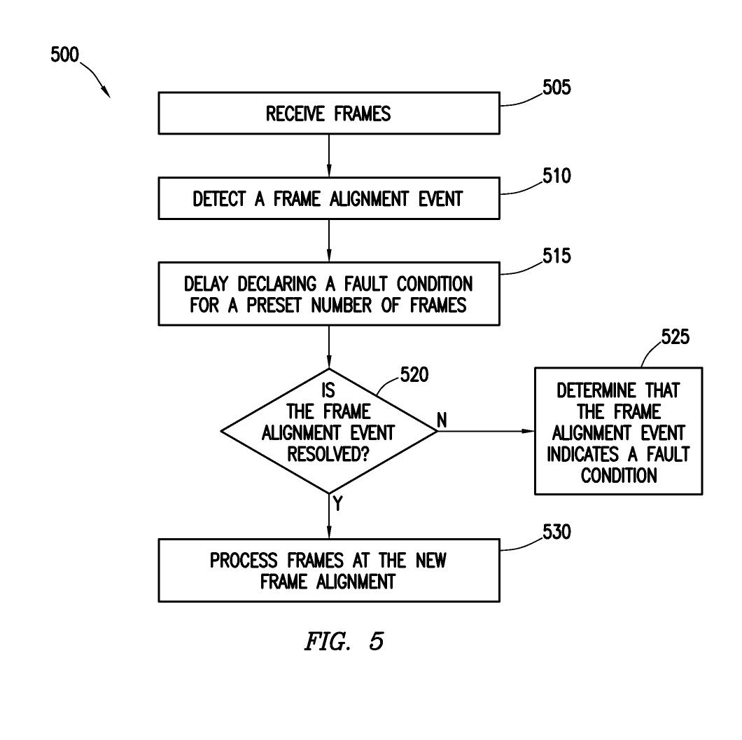

FIG. 4 illustrates a flow chart of method 400 for management of frame alignment events in accordance with some embodiments of the present disclosure. The steps of method 400 may be performed by various computer programs, models or any combination thereof. The programs and models may include instructions stored on computer-readable medium, and operable to perform, when executed, one or more of the steps described below. The computer-readable media may include any system, apparatus or device configured to store and retrieve programs or instructions such as a hard disk drive, a compact disc, flash memory or any other suitable device. The programs and models may be configured to direct a processor or other suitable unit to retrieve and execute the instructions from the computer-readable media. For illustrative purposes, method 400 is described with respect to network element 102 of FIGS. 1 and 2; however, method 400 may be used for management of frame alignment events with any suitable network element or network. Further, although discussed with reference to a processing system of a network element, portions or all of method 400 may be executed by a component of a network or network element.

At step 405, a processing system of a network element receives frames. For example, network interface 206-5a of network element 102-2 may receive OTU frames from network interface 206-2 of network element 102-1 as discussed with reference to FIG. 2.

At step 410, the processing system detects a frame alignment event. For example, frame alignment detector 212-5a of network element 102-2 may detect frame misalignment in a signal received from network interface 206-2. FAS bytes 312 of the received frame may indicate a different timing than the previous frame.

At step 415, the processing system receives a CI signal. For example, network interface 206-5a may communicate CI signal 224, e.g., a CI_FA_missing signal, that is received by a downstream block, such as, network interface 206-5b, switching element 205-2, a neighboring network element, or to any other suitable downstream component. CI signal 224, e.g., the CI_FA_missing signal, may be communicated after detection of one frame with frame misalignment. CI signal 224 may indicate to downstream blocks or components to suspend STAT field 314 monitoring for as long as CI signal 224, e.g., the CI_FA_missing signal, is detected, or until the IF state is indicated. As discussed with reference to FIG. 2, suspending monitoring of STAT field 314 may avoid mis-claiming AIS/LCK/OCI/LTC.

At step 420, the processing system disables the monitoring of a status field. For example, network interface 206-5b may disable monitoring of STAT field 314 as discussed with reference to FIGS. 2 and 3.

At step 425, the processing system determines if the frame alignment event is resolved. For example, after a predetermined number of consecutive frames and/or a finite period, the processing system may determine if the IF state is indicated. If the IF state is not indicated, e.g., frame alignment is still in OOF state, then the frame alignment event is not resolved and method 400 proceeds to step 430. If the IF state is indicated, then the frame alignment event is resolved and method 400 proceeds to step 435.

At step 430, the processing system determines that the frame alignment event indicates a fault condition. The processing system may declare LOF.

At step 435, the processing system enables monitoring of the status field. For example, network interface 206-5a may cease communicating CI_FA_missing and downstream blocks may enable monitoring of STAT field 314.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

Method 400 may be implemented using system 100, OTN 200, and/or any other system operable to implement method 400. In certain embodiments, method 400 may be implemented partially or fully in software and/or firmware embodied in memory.

FIG. 5 illustrates a flow chart of method 500 for management of frame alignment events in accordance with some embodiments of the present disclosure. The steps of method 500 may be performed by various computer programs, models or any combination thereof. The programs and models may include instructions stored on computer-readable medium, and operable to perform, when executed, one or more of the steps described below. The computer-readable media may include any system, apparatus or device configured to store and retrieve programs or instructions such as a hard disk drive, a compact disc, flash memory or any other suitable device. The programs and models may be configured to direct a processor or other suitable unit to retrieve and execute the instructions from the computer-readable media. For illustrative purposes, method 500 is described with respect to network element 102 of FIGS. 1 and 2; however, method 500 may be used for management of frame alignment events with any suitable network element or network. Further, although discussed with reference to a processing system of a network element, portions or all of method 500 may be executed by a component of a network or network element.

At step 505, a processing system of a network element receives frames. For example, network interface 206-5a of network element 102-2 may receive OTU frames from network interface 206-2 of network element 102-1 as discussed with reference to FIG. 2.

At step 510, the processing system detects a frame alignment event. For example, network interface 206-5a of network element 102-2 may detect frame misalignment event in a frame received from upstream network interface 206-2. FAS bytes 312 of the received frame may indicate a different timing than the previous frame, or STAT field 314 may indicate that frame alignment is missing as discussed with reference to FIGS. 2 and 3.

At step 515, the processing system delays declaring a fault condition for a preset number of frames. For example, before declaring a fault condition, network interface 206-5b may continue to monitor STAT field 314 for approximately six to seven frames rather than the typical approximately three frames.

At step 520, the processing system determines if the frame alignment event is resolved. For example, after the preset number of frames (e.g., approximately six or seven frames), the processing system may determine if the IF state is indicated. If the IF state is not indicated, e.g., frame alignment is still in OOF state, then the frame alignment event is not resolved and method 500 proceeds to step 525. If the IF state is indicated, then the frame alignment event is resolved and method 500 proceeds to step 530.

At step 525, the processing system determines that the frame alignment event indicates a fault condition. For example, the processing system may claim AIS/LCK/OCI/LTC alarms. The processing system may indicate an OOF state and declare LOF.

At step 530, the processing system continues processing frames at the new frame alignment. For example, network interface 206-5a may continue to process frames at the new frame alignment.

Although FIG. 5 discloses a particular number of steps to be taken with respect to method 500, method 500 may be executed with greater or lesser steps than those depicted in FIG. 5. In addition, although FIG. 5 discloses a certain order of steps to be taken with respect to method 500, the steps comprising method 500 may be completed in any suitable order.

Method 500 may be implemented using system 100, OTN 200, and/or any other system operable to implement method 500. In certain embodiments, method 500 may be implemented partially or fully in software and/or firmware embodied in memory.

Although the present disclosure and its advantages have been described in detail, it should be understood that various changes, substitutions and alternations can be made herein without departing from the spirit and scope of the disclosure as defined by the following claims.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving a plurality of frames by a network element;
detecting a frame alignment event by the network element;
receiving a characteristic information (CI) signal by the network element; and
disabling, based on the received CI signal, monitoring of a status field for a finite period.

2. The method of claim 1, wherein the CI signal comprises a CI_FA_missing signal.

3. The method of claim 1, wherein the finite period is based on a number of frames received by the network element.

4. The method of claim 3, wherein the number of frames is based on a number of frames that include the CI signal.

5. The method of claim 1, further comprising:
determining, by the network element, whether the frame alignment event is resolved; and
based on the frame alignment event being resolved, enabling monitoring of the status field.

6. The method of claim 1, further comprising enabling monitoring of the status field by the network element after receiving a number of frames.

7. The method of claim 1, further comprising enabling monitoring of the status field by the network element after two consecutive correct frame alignments are detected.

8. The method of claim 1, wherein the frame alignment event includes detecting that at least one frame is misaligned.

9. The method of claim 1, wherein status field is a portion of an Optical Data Unit (ODU) of an Optical Transport Unit (OTU) frame.

10. A network element comprising:
a processor configured to:
receive a plurality of frames;
detect a frame alignment event;
receive a characteristic information (CI) signal; and
disable, based on the received CI signal, monitoring of a status field for a finite period.

11. The network element of claim 10, wherein the CI signal comprises a CI_FA_missing signal.

12. The network element of claim 10, wherein the finite period is based on a number of frames received by the network element.

13. The network element of claim 12, wherein the number of frames is based on a number of frames that include the CI signal.

14. The network element of claim 10, wherein the processor is further configured to:
determine, by the network element, whether the frame alignment event is resolved; and
based on the frame alignment event being resolved, enable monitoring of the status field.

15. The network element of claim 10, wherein the processor is further configured to enable monitoring of the status field by the network element after receiving a number of frames.

16. The network element of claim 10, wherein the processor is further configured to enable monitoring of the status field by the network element after two consecutive correct frame alignments are detected.

17. A network element comprising:
a processor configured to:
receive a plurality of frames;
detect a frame alignment event; and
based on the frame alignment event, delay declaring a fault condition until a preset number of frames is received by the network element.

18. The network element of claim 17, wherein the preset number of frames is six frames.

19. The network element of claim 17, wherein the processor is further configured to:
after the preset number of frames has been received, determine whether the frame alignment event is resolved; and
based on the frame alignment event not being resolved, declare a fault condition.

20. The network element of claim 17, wherein the frame alignment event includes detecting that at least one frame is misaligned.
